(19) United States
(12) Patent Application Publication
(10) Pub. No.: US 2012/0059734 A1
(43) Pub. Date: Mar. 8, 2012

(54) Systems and Methods for Automated and Remote Fabrication of Fabric Awnings

(75) Inventors: Roy D. CHISM, San Antonio, TX (US); Richard W. Kalka, San Antonio, TX (US); Ricardo P. Herrera, San Antonio, TX (US); Ryan D. Chism, San Antonio, TX (US)

(73) Assignee: The Chism Company

(21) Appl. No.: 12/537,202

(22) Filed: Aug. 6, 2009

Related U.S. Application Data
(60) Provisional application No. 61/086,794, filed on Aug. 6, 2008.

(51) Int. Cl. G06Q 50/08; G06Q 50/04

(52) U.S. Cl. 705/26.5

(57) ABSTRACT

Systems and methods for automating the processes of fabricating standardized and/or customized structural components, supporting remotely located customers with a commercial service, manufacturing control of a centralized production system, to digitally execute the common, repetitive and necessary steps sequenced in advance of and in support of fabrication as well as the fabrication process itself. The operation of remote computer driven peripherals executing automated marking, cutting, and joining of materials is used to transform the materials into the components matching the description of the final product that the customer is seeking to produce.

### CROSS REFERENCES TO RELATED APPLICATIONS

This application claims the benefit under Title 35 United States Code §119(e) of U.S. Provisional Application 61/086,794 filed Aug. 6, 2008 the full disclosure of which is incorporated herein by reference.

### BACKGROUND OF THE INVENTION

1. Field of the Invention

The present invention relates generally to the field of customized fabrication of component assemblies and more particularly to fabric awning manufacturing and the automation of fabric awning fabrication and methods, enabling a remotely located customer (awning retailer, home owner, end user, or awning fabricating company) to exercise manufacturing control of a centralized and automated production system, thereby automating the processes of fabric awning fabrication.

2. Description of the Related Art

A fabric awning is comprised of a fabric cover and either a fixed or retractable supporting or tensioning frame usually constructed of rigid materials, wood, composites or metal—steel pipe, tubing or aluminum extrusion. Awning covers and awning frames can be fabricated as either standard product offerings of repetitive and unchanging design parameters or as custom product applications of non-repetitive and changing design parameters. Awning covers and awning frames are fabricated both in combinations with one another and independently of one another. For purposes of this application the term “awning” collectively applies to both standard and custom fabric awning covers and or fabric awning frames standard and custom, fixed and/or retractable in design and operation. Similarly, the terms awnings, covers and canopies are often used collectively and or interchangeably, again the terms canopies, covers and similar descriptions reference the same awning product for purposes of this application.

A series of common and repeated processes transpire in advance of and in support of the fabrication of an awning. The common and repetitive processes sequenced in advance of and in support of awning fabrication, as well as the fabrication process, itself include the product description/order entry, the creation of shop drawings detailing the awning frame design, description and materials specifications, a related bill of materials (a parts list detailing the individual awning framing components, quantities, finish cut lengths and angles of cut), fabric and frame materials ordering, logistics and scheduling, fabric patterning, and awning frame and or fabric component materials cutting, marking, joining and/or complete assembly into a finished product.

The economics and composition of the awning industry have evolved from the common industry perspective that the potential combinations of an awning's specification, design criteria and dimensional possibilities, especially of the custom application of the product, preclude the automated fabrication of fabric awnings. Given this traditional perspective, the awning industry utilizes a hand-built, craft-based approach to awning fabrication, manually producing awnings to order, matching project or customer specifications, design and dimensional criteria. The requirement for skilled labor has created a relatively fragmented industry consisting of local and regional based fabricating shops each employing small numbers of skilled craftsman. The skilled labor dependency and resulting market fragmentation combine to limit the scale of individual awning fabrication shops. Limited scale in turn limits revenue, minimizing earnings potential, negating capital investment and reinvestment. Accordingly, the industry at the fabrication level currently operates generally without (in whole or in part) the benefit of technology, automation, uniform quality, product standardization and economies of scale, while simultaneously experiencing the increasing scarcity and rising expense of skilled labor combined with the equally rapid rising expenses associated with supporting, training and maintaining skilled labor. While the fabric mills have admirably maintained the fundamental discipline of delivering ever increasing product value and enhanced product price performance, conversely the declining economics and limited productivity of the fabrication industry is adversely impacting the final, end product, and related consumer product selection, facilitating a sizable product displacement by awning solutions of more industrialized materials such as glass, concrete, steel and aluminum, thus impeding industry growth and further limiting profits to the industry as a whole.

Given the nature, condition, composition, economics and operating methods of the industry it would be extremely desirable to the industry and consumers alike to provide methods for minimizing both related support staffing and direct fabrication labor costs, methods positively impacting fabricating labor productivity, increasing fabricator output by multiples, and (relative to current industry performance) substantially collapsing the time required as measured from order to completion to produce an awning, in many instance approaching real time fabrication.

Given the nature of the industry it would be further beneficial to provide a simple fee for service distribution of a method for automating the processes of awning fabrication supporting remotely located customers with a commercial service, manufacturing control of a centralized production system thereby releasing fabricators from the financial burdens associated with capital investment as well as the operational burdens of recruitment, significant training and/or employment of specialized personnel as would be otherwise traditionally required to effectively support and operate specialized software and a complex operating system.

It would be further beneficial to incorporate into the methods a process and system whereby persons with no particular drafting experience, traditional design and or computer assisted design skills may benefit from the generation of one user, one off, automatically produced product drawings, visually depicting a model of the intended awning frame and design to be produced, included in the system, the electronic transmission of the drawing in a format allowing electronic editing, revision and or approval and return thereby initiating production.

It would be extremely desirable to provide a method and system whereby customers remotely produce fabric awning frames and/or covers from an electronically transferred digital scaled photograph of an existing building elevation and/or residential elevation, awning frame and or existing awning cover in need of replacement thereby greatly collapsing the time and skill level required to execute an otherwise demanding, time consuming, skilled labor product application.

It would also be desirable to provide a method and system whereby customers could produce a one-of-a-kind or simple single, one off awning supported by production metrics and costs traditionally associated with market economies of scale.

It would also be desirable to provide a flexible method of modular process selections whereby customers select and operate one, several or all elements of the process as needed in support and enhancement of the customer's existing internal means of fabrication.

Therefore, in the interest of the renewed and sustained growth of the industry, the resulting enhanced consumer value, the convenience of product customization and speed to market, it would be extremely desirable to the industry and consumers alike to provide a method automating the processes of awning fabrication supporting remotely located customers with manufacturing control of a centralized manufacturing system automating and industrializing the processes of awning fabrication.

While common industry perspective precludes automated awning fabrication, awnings remain mathematically and digitally definable, relationship based objects subject to manipulation by design codes addressing virtually any level of product customization. Similarly, it is now possible to digitally record, express and transmit the knowledge, decisions, actions and sequences applied by a craftsman skilled in the art of awning fabrication to computer driven peripherals coded to automatically mark, cut and join materials into components, and assemblies and finished awnings matching the description of the awning the customer is seeking to produce. Combined, these characteristics form the basis of the automation of fabric awning fabrication described herein.

The industry recognizes that craftsman, their talents, processes and fabrication equipment used to produce awnings are readily transferable to the production of any number of similarly aligned product applications. Awning companies typically advertise and offer their expertise in the fabrication of, for example, tents, upholstery, marine and industrial product applications. These applications along with any number of additional similar applications represent relationship based mathematically and digitally definable fabric and or fabric and frame product applications, subject to manipulation by design codes addressing virtually any level of product customization. As such it is possible to adapt, manipulate or otherwise modify the existing automated processes and code used with the fabrication of awnings and or create a parallel code to digitally record, express and transmit the knowledge, decisions, actions and sequences applied by the craftsman more broadly skilled in the art of general purpose fabric fitting, patterning, cutting and sewing and or framing design, cutting and framing assembly applications to the same or similar computer driven peripherals coded to automatically mark, cut and join awning materials into components, and assemblies matching the description of the product, including but not limited to upholstery, outdoor furniture, industrial and marine applications that the customer is seeking to produce. Combined, these characteristics form a general purpose business and production method offering broad economic appeal and cross industry application, a method of expansive general purpose utility.

### SUMMARY OF THE INVENTION

A system and method automating the processes of fabric awning fabrication, generating as a commercial service to customers:

(a) Information goods in the form of products and services distributed in digital form embodying the common, repetitive and necessary steps sequenced in advance of and in support of awning fabrication including web based order entry, digital product frame design, digital, cad based, geometric and or digital photographically based fabric patterning, and the generation of related bills of materials;

(b) Supporting remotely located customers with manufacturing control of a centralized production system executing automated electronic materials ordering, logistics and production scheduling, digital plot and cut files, automated fabric pattern nesting as well as the fabrication process itself, the operation of remote computer driven peripherals executing automated marking, cutting, and joining of the materials into the components matching the description of the awning the customer is seeking to assemble;

(c) Supporting remotely located fabricating customers operating their own computer driven fabricating equipment, providing automated information goods, as well as automated fabric ordering, automated digital fabric patterning and automated digital fabric cut and mark files electronically transferred in a format compatible with the customers computer driven fabricating equipment thus converting a customer's discrete stand alone production equipment into an automated decentralized production system; and

(d) Supporting remotely located retail customers and end users with a means of manufacturing control of a centralized production system to order and produce the complete end product matching the description of the product the customer is seeking to purchase.

### BRIEF DESCRIPTION OF THE DRAWINGS

FIG. 1 is a diagram illustrating a web based communication environment supporting remote order entry, digital design, design review, modification and approval, fabric patterning, bills of materials generation, automated materials ordering, scheduling, and the remote computer driven product marking, cutting, and joining peripherals.

FIG. 2 is an illustration of the customer's options and selections sequenced in advance of and occurring in support of awning fabrication consisting of web based order entry, digital product design and patterning including electronic review and editing, generation of related bills of materials, electronic materials ordering, logistics and production scheduling.

FIGS. 3-12 are flowcharts which together depict the process of complete order web connected hardware and computer driven peripherals in support of automated processes and production peripheral options available in the selection of processes in advance of and in support of automated fabrication. Specifically:

FIG. 3 provides an overview schematic flowchart showing web ordering access to the various functional automation modules of the system of the present invention.

FIG. 4 is a flowchart showing the method steps associated with the automated product design module of the system of the present invention.

FIG. 5 is a flowchart showing the method steps associated with the automated bill of framing materials module of the system of the present invention.

FIG. 6 is a flowchart showing the method steps associated with the automated fabric patterning (based on design software) module of the system of the present invention.

FIG. 7 is a flowchart showing the method steps associated with the automated fabric patterning (based on scaled digital photos) module of the system of the present invention.

FIG. 8 is a flowchart showing the method steps associated with the automated ordering of materials (materials definition and selection) module of the system of the present invention.

FIG. 9 is a flowchart showing the method steps associated with the automated frame production (cutting and layout) module of the system of the present invention.

FIG. 10 is a flowchart showing the method steps associated with the automated frame production (robotic assembly) module of the system of the present invention.

FIG. 11 is a flowchart showing the method steps associated with the automated fabric production (assembly) module of the system of the present invention.

FIG. 12 is a flowchart showing the method steps associated with the drawing request (with cut components and fabric) module of the system of the present invention.

### DETAILED DESCRIPTION OF THE PREFERRED EMBODIMENTS

In accordance with an exemplary embodiment, the present invention automates the process of awning fabrication transforming the basis of production from a manual hand built fabricating model into an industrialized medium of product generation.

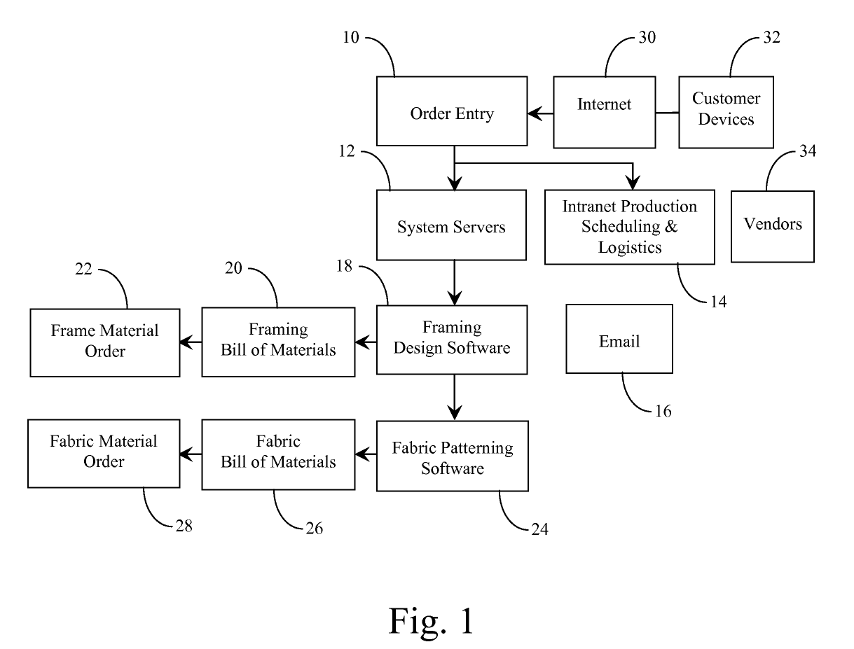

Referring to FIG. 1 there is shown a process flow diagram illustrating an Internet/web-based system supporting the automation of the processes of awning fabrication and providing remotely located customers with a commercial service, manufacturing control of a centralized production system. FIG. 1 is a diagram illustrating a web based communication environment supporting remote order entry, digital design, design review, modification and approval, fabric patterning, bills of materials generation, automated materials ordering, scheduling and the remote computer driven product marking, cutting, and joining peripherals.

The web based communication environment shown in FIG. 1 is centered on order entry component 10. Remote customers, by and through customer devices 32, and over the Internet 30 communicate order entry 10 to the processing system of the present invention. Order entry 10 is communicated to system servers 12 and into an intranet production scheduling and logistics component 14. Associated with these web-based components are additional Internet connected components including vendors 34 and email servers 16.

The system servers 12 communicate order entry 10 into design software 18 which in the preferred embodiment of the present invention breaks down the task into fabric and framing components. A framing bill of materials 20 is prepared followed by an automatic frame material order 22. In a similar manner, patterning software 24 generates a fabric bill of materials 26 followed by the automatic fabric material order 28.

Prior to initiating an order, a customer using any web compatible communication and processing device uses the Internet to link to the web based portal. Valid users of the system enter the application employing logon/password access. Upon authorized entry, the customer subsequently specifies the desired production scope selecting one, several, or all of the common, repetitive and necessary steps sequenced in advance of and occurring in support of awning fabrication detailed in the illustration as automated digital frame design, generation of related framing bills of materials, automated fabric patterning either geometric or digitally photographic based, generation of related fabric bills of materials, automatic electronic materials ordering, automatic logistics and production scheduling as well as the automated production process itself, the operation of remote computer driven peripherals automatically marking, cutting, and joining materials into components, assemblies, and/or finished awnings thereby matching the customers initial order.

With the scope of work defined, the system generates an order template, an automated system interface into which the customer populates the numerical and discursive description of the awning he is seeking to produce. The descriptive information is entered into the system interface by the customer one time, captured, retained within and disseminated throughout the automated system linking with automated design detailing, costing, processing and operating software.

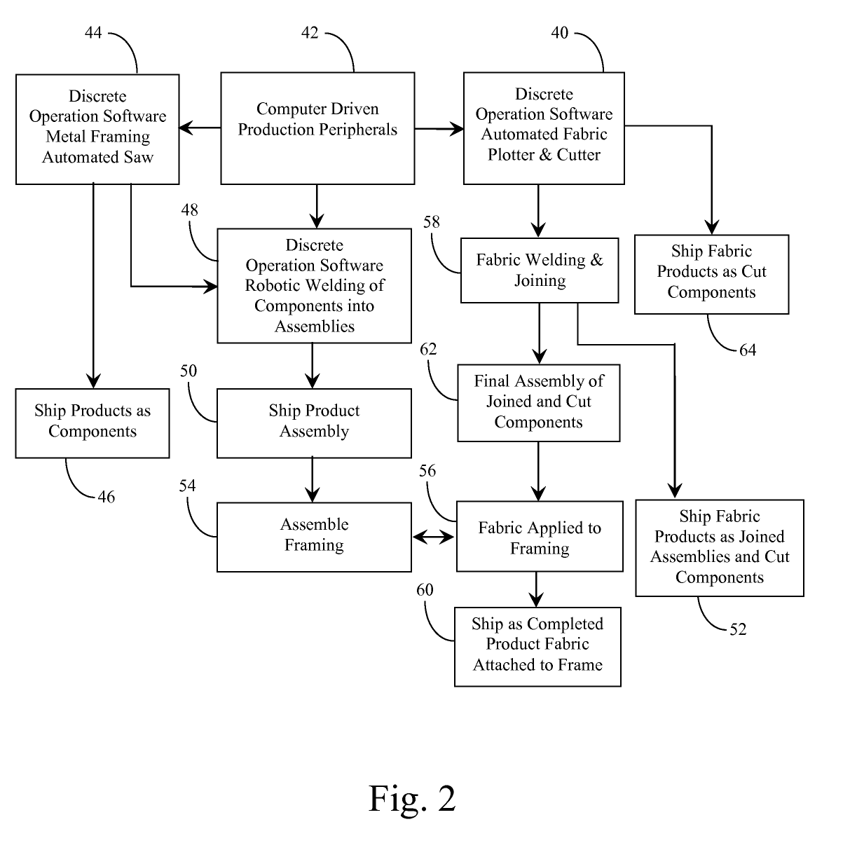

FIG. 2 is an illustration of the customer's options and selections sequenced in advance of and occurring in support of awning fabrication consisting of web based order entry, digital product design and patterning including electronic review and editing, generation of related bills of materials, electronic materials ordering, logistics and production scheduling.

FIG. 2 generally describes the various paths or choices of procedures that the customer may implement to obtain a more or less finished final product. Various computer driven production peripherals 42 are shown in a functional relationship in FIG. 2 including discrete operations software automated fabric cutter and plotter 40 as well as discrete operations software metal framing automated sawline 44. In a short and direct process path, a customer may simply obtain shipped fabric products as cut components 64 or may simply receive metal products as components for the framing system 46. Alternately, further production and fabrication can occur as shown in FIG. 2. Discrete operations software for the robotic welding of framing components into assemblies may occur at 48 followed by the shipment of the product assembly 50. Thereafter, the consumer and/or intermediary may assemble the framing at 54.

If the framing has been assembled by any of the actors (as identified above), then the fabric may be applied to the framing at 56. This would occur after fabric welding and joining (sewing) at 58 and final assembly of joined and cut components at 62. The result may then be shipped as a completed product, fabric attached to frame at 60. Alternately, within the fabric production path, fabric welding and joining 58 may be followed immediately by the shipment of fabric products as joined assemblies and cut components at 52. In this manner, it can be seen how a more or less complete end product can be requested and constructed by the consumer and/or end user of the system of the present invention.

Common to all work scope selections contained within FIG. 2 the automated system combines the customer's scope selection and awning description with automated costing generating and emailing a cost proposal to the customer for review and acceptance. Customer acceptance automatically initiates the production system's processing of the customer's scope selection. As awnings are relationship based products the majority of the processes are interrelated and as such are performed in a designated sequence.

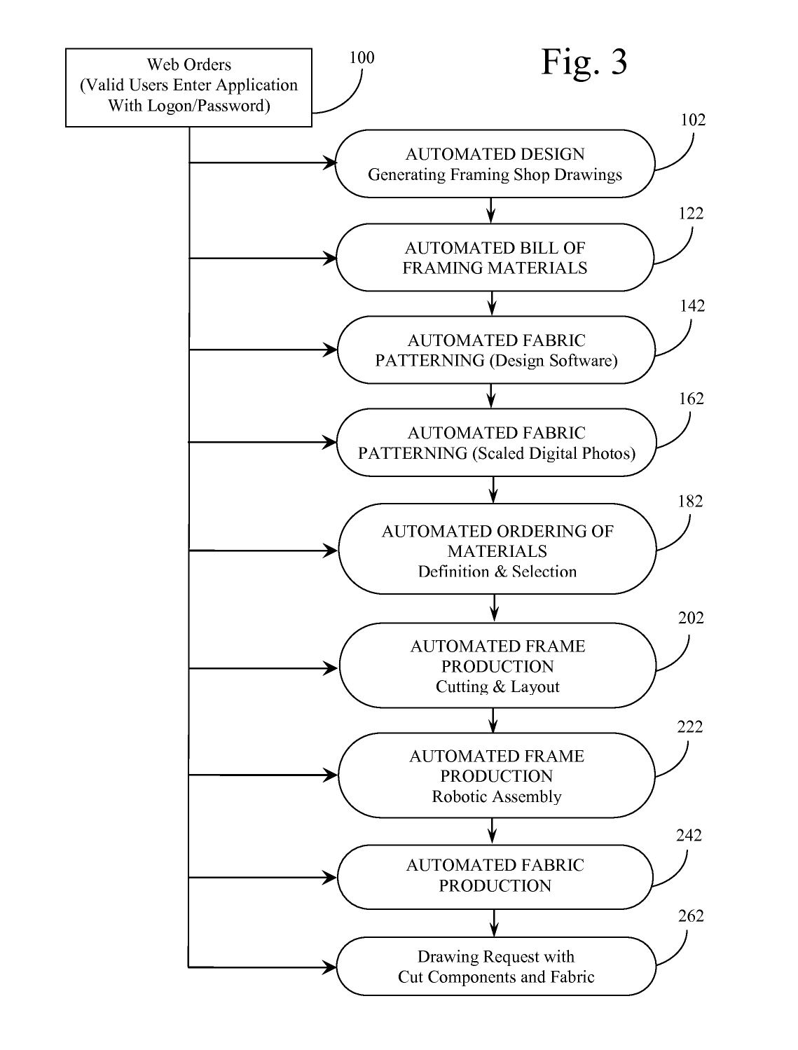

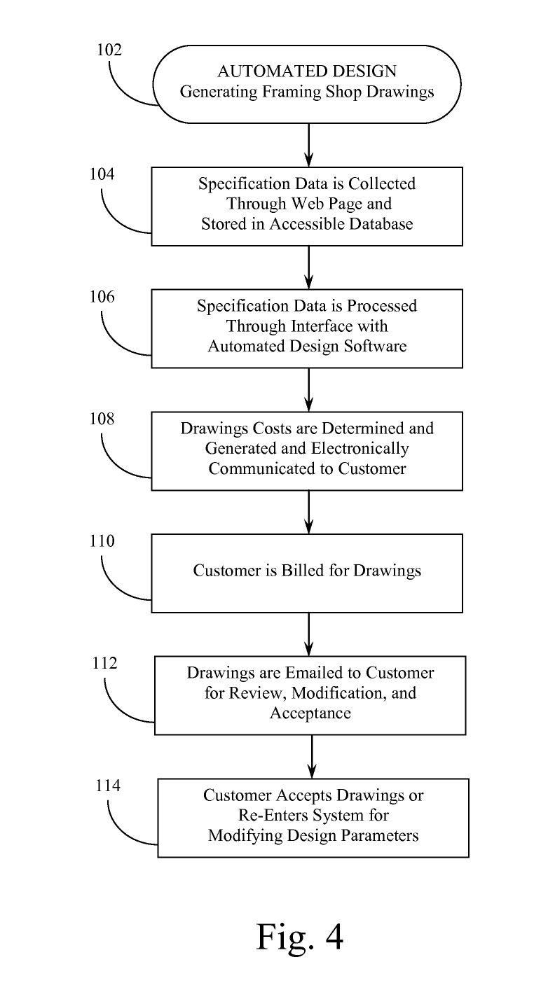

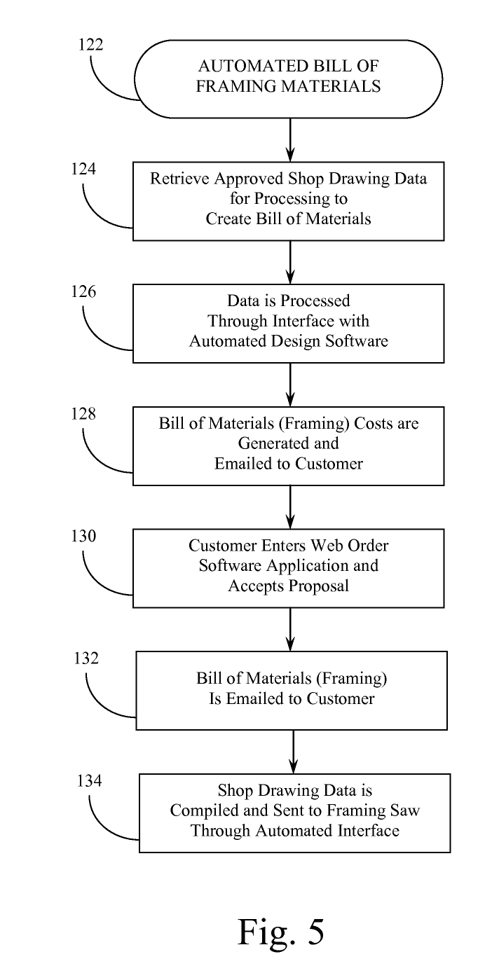

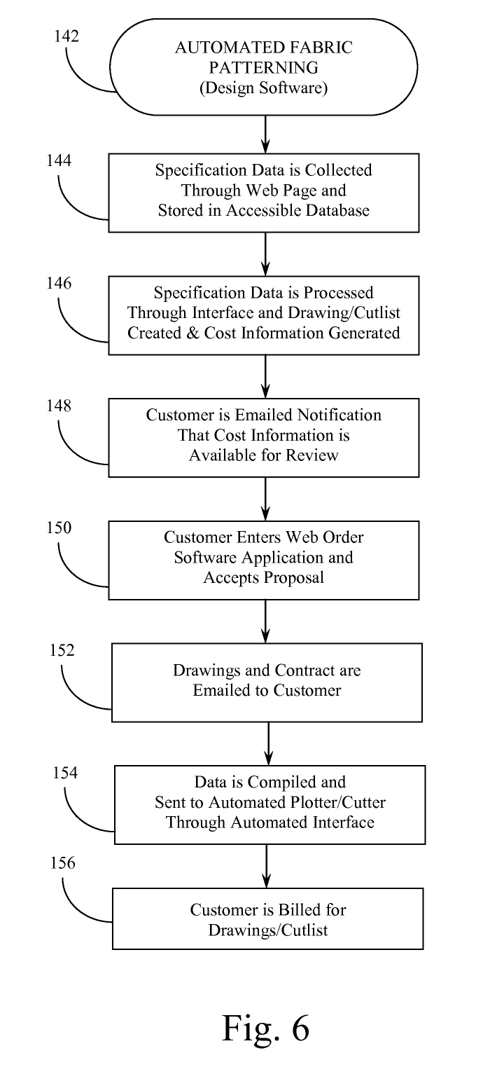

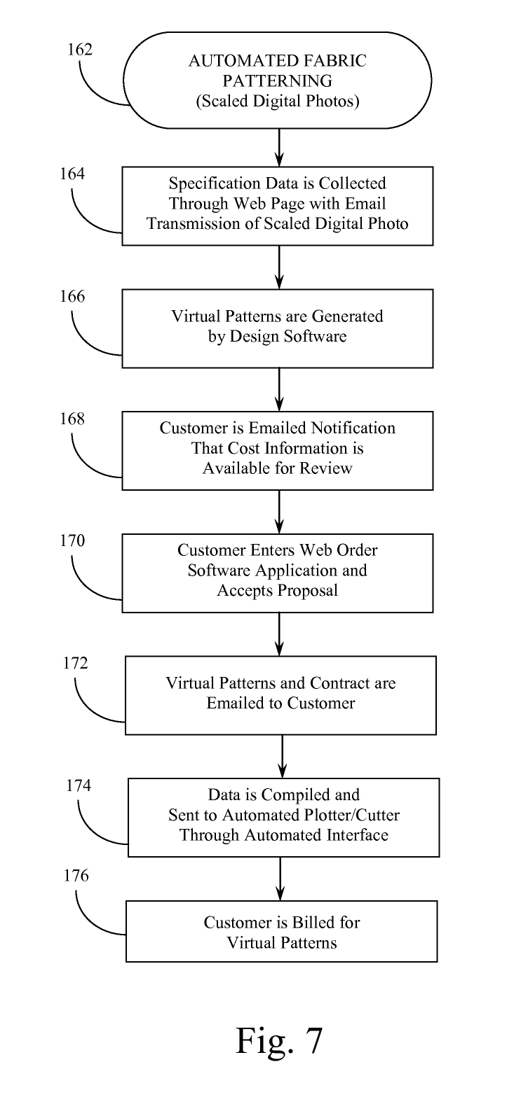

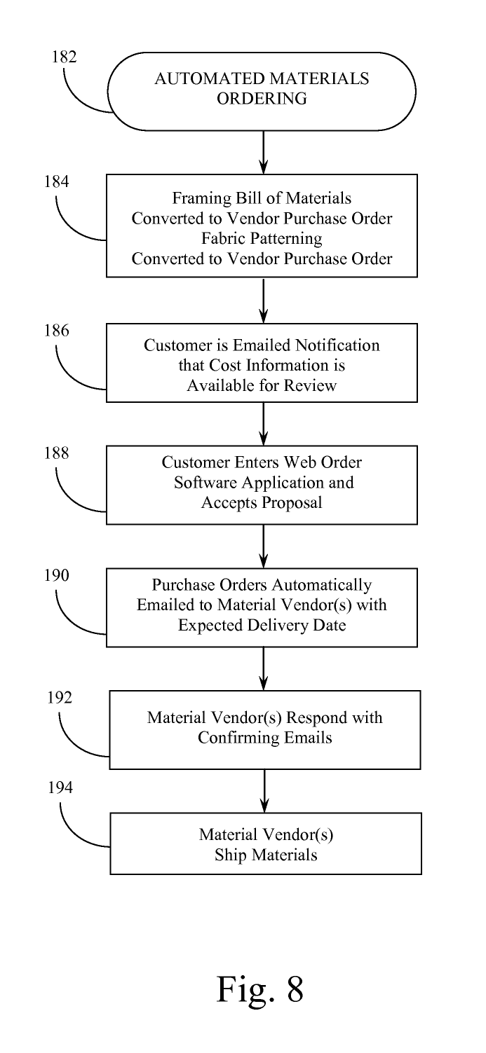

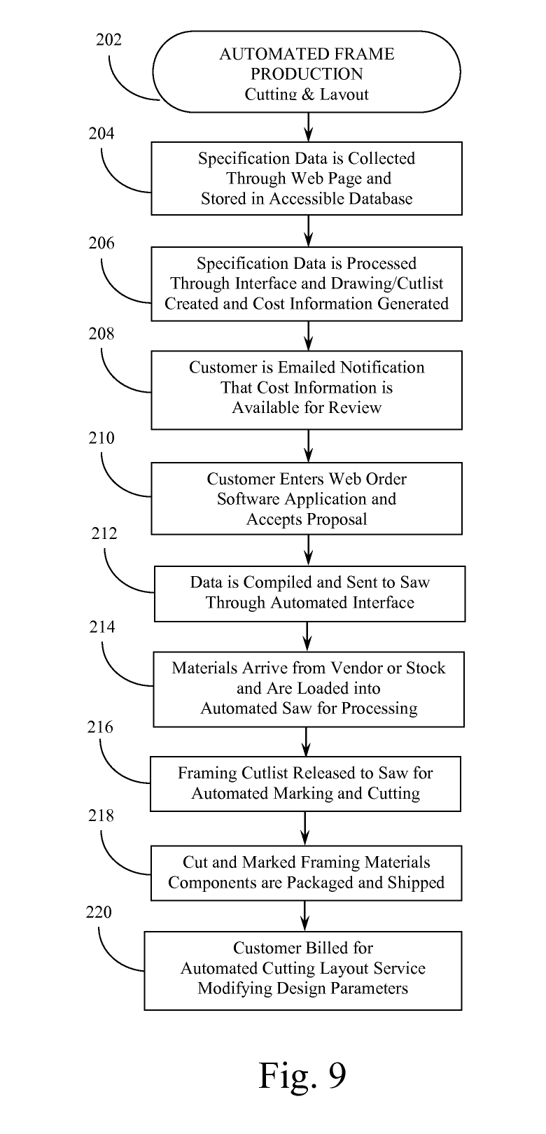

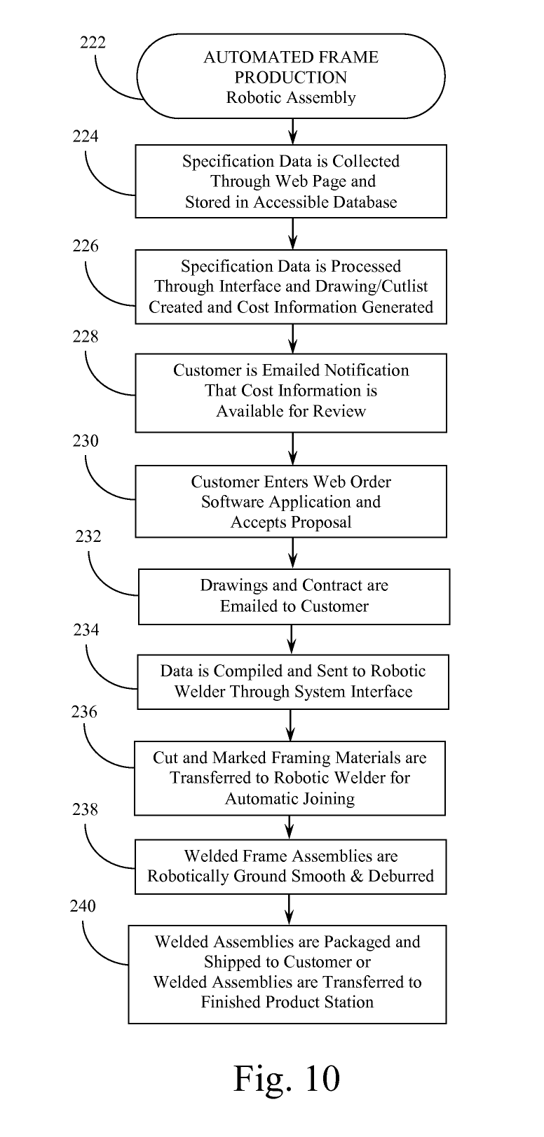

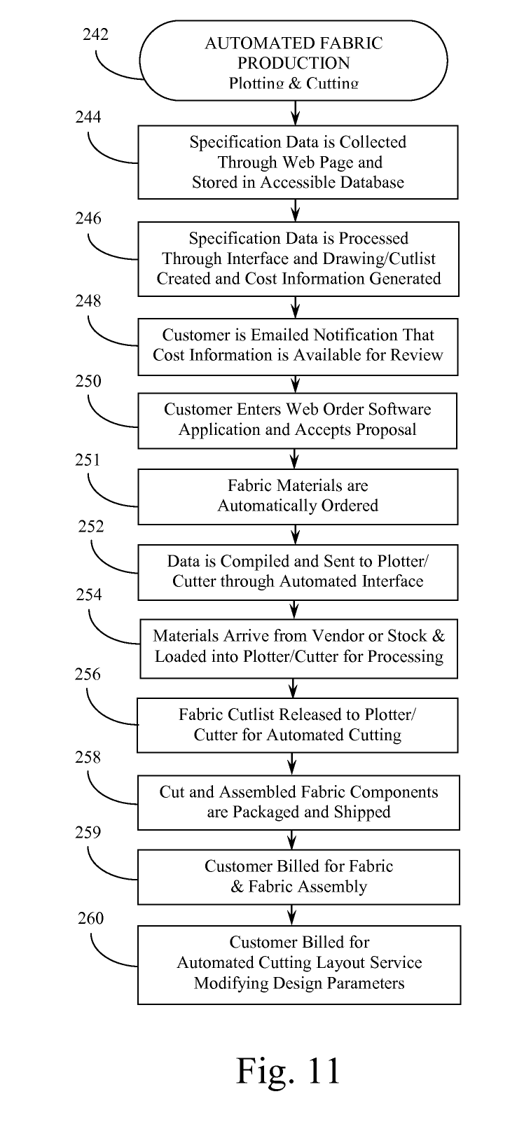

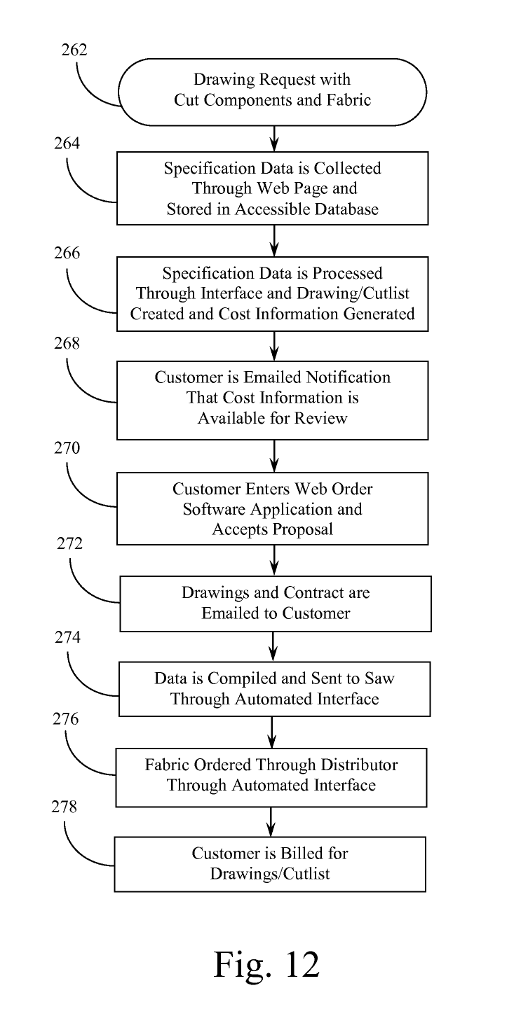

Reference is now made to FIG. 3 which provides an overview schematic flowchart showing web ordering access to the various functional modules of the system of the present invention. The overall Web Orders Process (valid users enter application with logon/password) is shown at Step 100. The Automated Design Module for generating framing shop drawings is shown at Step 102 and in FIG. 4. The Automated Bill of Framing Materials Module is shown at Step 122 and in FIG. 5. The Automated Fabric Patterning Module (based on the use of design tutorial software) is shown at Step 142 and in FIG. 6. The Automated Fabric Patterning Module (based on the use of scaled digital photos) is shown at Step 162 and in FIG. 7. The Automated Materials Ordering Module is shown at Step 182 and in FIG. 8. The Automated Frame Production Module (cutting & layout) is shown at Step 202 and in FIG. 9. The Automated Frame Production Module (based on robotic assembly) is shown at Step 222 and in FIG. 10. The Automated Fabric Production Module is shown at Step 242 and in FIG. 11. Finally, the Drawing Request with Cut Components and Fabric Module is shown at Step 262 and in FIG. 12.

In the case of an automated design selection generating a framing shop drawing, the order is electronically entered into the automated system on a one awning, one user at a time basis and processed individually within the system by combining the content populated within the order template and design software with the resulting drawing emailed to the customer for review. Provision exists for the customer upon review to re-enter the system, modify the numerical and or discursive description of the awning and resubmit for automatic processing generating the revised and desired drawing matching the customer's design intent. The drawing produced is of a quality suitable to serve as an architectural or project submittal document and or a fabrication shop reference tool.

Reference is made to FIG. 4 which is a flowchart showing the method steps associated with one of the automated design modules of the system of the present invention. Automated Design Generating Framing Shop Drawings is shown generally at Step 102. In the process, Specification Data is collected through the web page portal and stored in an accessible database at Step 104. Specification Data is processed through an interface with automated design software at Step 106. Drawing costs are determined and generated, and electronically communicated to the customer at Step 108. The customer is billed for the drawings at Step 110. Drawings are emailed to customer for review, modification, and acceptance at Step 112. The customer accepts drawings or re-enters the system for modifying design parameters at Step 114.

Similarly upon cost and order approval a customer's selection of an automated bill of frame materials herein referred to as a BOM, the order is electronically entered into the automated system and processed on a one awning, one user at a time basis generated from design software processing the customer's awning description creating a scheduled materials format easily readable and useful to any metal fabrication shop detailing all descriptive, dimensional, degrees of angle and quantities of each frame component contained within the related frame shop drawing. Once generated the BOM is automatically emailed to the customer as a finished product. The complied data is simultaneously transferred within the automated system to the automated saw line for use in generating cut framing components.

Reference is made to FIG. 5 which is a flowchart showing the method steps associated with the automated bill of framing material module of the system of the present invention. The overall automated bill of framing materials process is initiated at Step 122. The process initially retrieves approved shop drawing data for processing to create the bill of materials at Step 124. Data is processed through an interface with automated design software at Step 126. Bill of materials (for framing) costs are generated and emailed to the customer at Step 128. The customer enters the web order software application and accepts the billed proposal at Step 130. The final bill of materials for framing is emailed to the customer at Step 132. The shop drawing data is compiled and sent to the framing saw through an automated interface at Step 134.

Automated fabric patterning generated from design software upon cost and order approval combines within the automated system the geometry expressed in the related frame shop drawing with the rules and standards (expressed within the application code as proprietary automated digital content) of a craftsman skilled in the art of patterning awning fabric covers to create a digital pattern and/or printable dimensioned and scaled drawing of all cut components and/or a printable BOM expressing cut and mark dimensions for each fabric component. Again the automated fabric pattern is emailed to the customer in a digitally downloadable format capable of being read and executed by a customer's remote plotter cutter or as a printable file for reference in hand cut manual shops. The complied data is simultaneously transferred within the production system to the automated fabric plotter/cuter for use in generating cut fabric components.

Reference is made to FIG. 6 which is a flowchart showing the method steps associated with the automated fabric patterning (based on design software) module of the system of the present invention. The automated fabric patterning (based on the use of design software) module is initiated at Step 142. Specification data is collected through the web page portal and stored in an accessible database at Step 144. Specification data is then processed through an interface and a drawing/cutlist is created with cost information generated and provided at Step 146. The customer is emailed notification that cost information is available for review at Step 148. The customer then enters the web portal order software application and accepts the proposal at Step 150. Drawings and contract are emailed to the customer at Step 152. Fabric data is compiled and sent to an automated plotter/cutter through an automated interface at Step 154. The customer is then billed for the drawings/cutlist at Step 156.

Automated fabric patterning generated from scaled digital photos upon cost and order approval combines within the automated system a digital scaled photo of the object or in this application the awning frame the customer is seeking to cover with design software and standards (expressed within the application as automated digital content) of a craftsman skilled in the art of patterning awning fabric covers to create a digital pattern and/or printable dimensioned and scaled drawing of all cut components and/or a printable BOM expressing cut and mark dimensions for each fabric component. Again the automated fabric pattern is emailed to the customer in a digitally downloadable format capable of being read and executed by a customer's remote plotter cutter or as a printable file for reference in hand cut manual shops. The complied data is simultaneously transferred within the production system to the automated fabric plotter/cuter for use in generating cut fabric components.

Reference is now made to FIG. 7 which is a flowchart showing the method steps associated with the automated fabric patterning (based on the use of scaled digital photos) module of the system of the present invention. The automated fabric patterning (scaled digital photos) module is initiated at Step 162. Specification data is collected through the web page portal with email transmission of the scaled digital photo at Step 164. Virtual patterns are thereafter generated by the design software of the system of the present invention at Step 166. The customer is emailed or otherwise electronically notified that cost information is available for review at Step 168. The customer once again enters the web based (portal) order software application and accepts the proposal at Step 170. Virtual patterns and contract are emailed to the customer at Step 172. Fabric data is compiled and sent to an automated plotter/cutter through an automated interface at Step 174. The customer is billed for the virtual patterns at Step 176.

Automated materials ordering, again upon cost and order approval, interfaces the data compiled in the fabric and frame material “B.O.M.” with the vendors' corresponding catalogue codes, automatically creating and emailing an electronic purchase order to the appropriate vendor for bulk materials processing and shipment. A reciprocating email confirming order receipt and materials shipment is generated and emailed to the automated system by the vendors system. Reference is made to FIG. 8 which is a flowchart showing the method steps associated with the automated ordering of materials (materials definition and selection) module of the system of the present invention. The automated materials ordering module is initiated at Step 182. The framing bill of materials is converted to a vendor purchase order and the fabric patterning of materials is converted to a vendor purchase order at Step 184. The customer is emailed notified that cost information is available for review at Step 186. The customer enters the web based (portal) order software application and accepts the prepared proposal at Step 188. Purchase Orders are automatically emailed to the respective material vendor(s) with expected delivery dates defined at Step 190. Material vendor(s) respond with confirming emails at Step 192. Finally, material vendor(s) ship the ordered materials at Step 194.

Automated Frame Production cutting and marking following cost and order approval is achieved as indicated by interfacing within the production system the frame materials data compiled in the design process with an automated saw and frame processing line, a remote computer driven peripheral robotically moving frame materials into position to measure, mark and cut bulk framing materials into components matching the initial design the customer has entered. The resulting frame components, depending upon the customers work scope selections, can either be packaged and shipped to the customer for manual joining and assembly or transferred to the systems robotic welding station for automated processing.

Reference is next made to FIG. 9 which is a flowchart showing the method steps associated with the automated frame production (cutting and layout) module of the system of the present invention. This automated frame production module for the cutting and layout of the frame material is initiated at Step 202. Specification data is (or has been) collected through the web page (portal) and stored in an accessible database at Step 204. The specification data is processed through an interface and a drawing/cutlist is created and cost information is generated at Step 206. The customer is email notified that the cost information is available for review at Step 208. The customer enters the web order software application and accepts the prepared proposal at Step 210. Data is then compiled and sent to the frame saw through an automated interface at Step 212. The necessary materials arrive from the vendor or from stock and are loaded into the automated saw for processing at Step 214. The framing cutlist is then released to the saw for automated marking and cutting of the framing components at Step 216. The cut and marked framing material components may then be packaged and shipped at Step 218. The customer is then billed for the automated cutting and layout service as modified by any new design parameters at Step 220.

The automated frame assembly process following cost and order approval is achieved as indicated generally above by interfacing within the production system the frame materials data compiled in the design process with another remote computer driven peripheral, namely an automated robotic welding station, physically transforming the measured, marked and cut frame components into welded assemblies and or finished awning frames matching the initial design the customer has entered. The finished product is subsequently packaged and shipped to the customer concluding the automated awning fabrication process and the remotely located customer manufacturing control of a centralized production system automating the processes of awning fabrication.

Reference is made to FIG. 10 which is a flowchart showing the method steps associated with the above described automated frame production (with robotic assembly) module of the system of the present invention. This automated frame production with robotic assembly module is initiated at Step 222. The specification data is (or has been) collected through the web page (portal) and stored in an accessible database at Step 224. Specification data is processed through interface and drawing/cutlist created and cost information is generated at Step 226. The customer is then email notified that the cost information is available for review at Step 228. The customer enters the web based order software application and accepts the final proposal at Step 230. The appropriate drawings and contract are emailed to the customer at Step 232. The data is also then compiled and sent to a robotic welder through a system interface at Step 234. Cut and marked framing materials are transferred to the robotic welder for automatic joining at Step 236. Welded frame assemblies are robotically ground smooth and deburred at Step 238. Welded assemblies are then packaged and shipped to the customer or are transferred to a finished product station at Step 240.

Automated fabric production cutting and marking, following cost and order approval, is achieved as indicated by interfacing within the production system the fabric materials data compiled in the design process with an automated fabric plotter/cutter, a remote computer driven peripheral automatically marking and cutting bulk fabric bolts into components matching the initial design the customer has entered. The resulting fabric components are, depending upon the customer's production order selections, either packaged and shipped to the customer for manual joining and assembly into finished awning covers, or retained and physically transferred within the system for subsequent joining by automated computer driven programmable sewing and or fabric welding machines and subsequent packaging and shipment to the customer.

Reference is therefore made to FIG. 11 which is a flowchart showing the method steps associated with the automated fabric production module of the system of the present invention. The automated fabric production plotting and cutting module is initiated at Step 242. Once again, the specification data is (or has been) collected through the web page (portal) and stored in an accessible database at Step 244. The specification data is processed through an interface and the drawing/cutlist is created and cost information generated at Step 246. The customer is email notified that the cost information is available for review at Step 248. The customer enters the web based order software application and accepts the prepared proposal at Step 250. The relevant data is compiled and sent to the plotter/cutter through an automated interface at Step 252. The fabric materials arrive from the vendor(s) or from stock and are loaded into the plotter/cutter for processing at Step 254. The fabric cutlist is then released to the plotter/cutter for automated cutting at Step 256. The cut and assembled fabric components may then be packaged and shipped as shown at Step 258. The customer is then billed for the automated cutting/layout service with any modified design parameters at Step 260.

Reference is finally made to FIG. 12 which is a flowchart showing the method steps associated with the basic design drawing request (with cut components and fabric) module of the system of the present invention. The basic design drawing request with cut components and fabric process is initiated at Step 262. As usual, specification data is collected through the web page portal and stored in an accessible database at Step 264. The specification data is then processed through an interface and the drawing/cutlist is created with all of the relevant cost information generated at Step 266. The customer is emailed notification that cost information is available for review at Step 268. The customer enters the web based order software application and accepts the proposal as prepared at Step 270. The final drawings and contract are emailed to the customer at Step 272. At the same time, data is compiled and sent to the framing saw through an automated interface at Step 274. The fabric may be ordered through a distributor, also through an automated interface at Step 276. The customer is then finally billed for the drawings/cutlist provided as the product of the process at Step 278.

Although the present invention has been described in terms of the foregoing preferred embodiments, this description has been provided by way of explanation only, and is not intended to be construed as a limitation of the invention. Those skilled in the art will recognize modifications of the present invention that might accommodate specific fabricated products and/or fabrication requirements. Those skilled in the art will further recognize additional methods for modifying the processes defined to accommodate variations in buildings and structures to which the fabricated systems are directed. Such modifications, as to structure, order, materials, and even material construction techniques, where such modifications are coincidental to the type of automated fabrication process involved, do not necessarily depart from the spirit and scope of the invention.

We claim:

1. A system for automating the processes of fabric awning design and fabrication supporting remotely located customers, the system comprising:
a wide area network portal for allowing remotely located customers to provide information and data to the design and fabrication processes;
an automated frame design processor module for generating framing shop drawings according to the information and data provided by the remotely located customers;
an automated fabric patterning design processor module for generating fabric patterns according to the information and data provided by the remotely located customers;
an automated data processor operable in conjunction with a materials pricing database for generating a bill of framing materials according to the generated framing shop drawings and a bill of fabric materials according to the generated fabric patterns;
an automated data processor operable in conjunction with a materials catalog database for defining, selecting, and ordering materials according to the generated framing shop drawings and the generated fabric patterns;
a frame production system for cutting, laying out, and assembling framing materials according to the generated framing shop drawings;
a fabric production system for cutting, laying out, and assembling fabric materials according to the generated fabric patterns; and
an automated shipment processor for packaging and directing the delivery of the produced framing materials and the produced fabric materials.

2. The system of claim 1 further comprising a digital image design processor for automatically extracting production dimensions from a scaled digital image provided by the remotely located customer through the network portal.

3. The system of claim 1 further comprising a design tutorial software module operable through the network portal for guiding the remotely located customer through a design process and automatically extracting production dimensions from a resulting product design.

4. The system of claim 1 further comprising a design processor and image generator for generating a set of preliminary design images of the requested product for review and approval and/or modification by the remotely located customers.

5. The system of claim 1 wherein the frame production system comprises:
a computer controlled saw table system having a feed stock supply of framing material and a mechanism for delivering cut framing stock;
a computer controlled jig table for receiving and arranging the cut framing stock;
a computer controlled welding/soldering system for assembling and connecting the arranged framing stock.

6. The system of claim 1 wherein the fabric production system comprises:
a computer controlled cutting table system having a feed stock supply of fabric material and a mechanism for moving and delivering cut fabric components;
a computer controlled fabric bonding system for assembling and connecting the cut fabric components.

7. The system of claim 1 wherein the fabric production system comprises:
a computer controlled cutting table system having a feed stock supply of fabric material and a mechanism for moving and delivering cut fabric components;
a computer controlled fabric sewing system for assembling and connecting the cut fabric components.

8. The system of claim 1 wherein each of the components within the system are in data communication with each other through a local area network.

9. The system of claim 1 further comprising an automated materials inventory and stocking system for receiving framing and fabric material into inventory stock, identifying the location of the material upon demand, and delivering the material to the fabricating components of the system as required by the system.

10. A method for automating the processes of fabric awning design and fabrication supporting remotely located customers, the method comprising the steps of:
providing a wide area network portal for allowing remotely located customers to provide information and data to the design and fabrication processes;
receiving information and data through the wide area network portal from remotely located customers defining the fabric awning requirements;
automatically generating digital data framing shop drawings according to the information and data provided by the remotely located customers;
automatically generating digital data fabric patterns according to the information and data provided by the remotely located customers;
referencing a materials pricing digital database and generating a bill of framing materials according to the generated framing shop drawings and a bill of fabric materials according to the generated fabric patterns;
automatically defining, selecting, and ordering materials according to the generated framing shop drawings and the generated fabric patterns;
automatically cutting, laying out, and assembling framing materials according to the generated framing shop drawings;
automatically cutting, laying out, and assembling fabric materials according to the generated fabric patterns; and
packaging and directing the delivery of the produced framing materials and the produced fabric materials.

11. The method of claim 10 further comprising the step of automatically extracting production dimensions from a scaled digital image provided by the remotely located customer through the network portal.

12. The method of claim 10 further comprising the step of guiding the remotely located customer through a design process through the network portal and automatically extracting production dimensions from a resulting product design.

13. The method of claim 10 further comprising the steps of:
generating a set of preliminary design images of the requested product for review by the remotely located customers;
the remotely located customers modifying the information and data so as to modify the set of preliminary design images; and
resubmitting the modified information and data through the wide area network portal.

14. The method of claim 10 wherein the step of automatically cutting, laying out, and assembling the frame materials comprises the steps of:
providing a feed stock supply of framing material to a computer controlled saw table system and cutting the framing stock as required;
delivering the cut framing stock from the saw table system to a computer controlled jig table; and
arranging the cut framing stock and providing a computer controlled welding/soldering system for assembling and connecting the arranged framing stock.

15. The method of claim 10 wherein the step of automatically cutting, laying out, and assembling the fabric materials comprises the steps of:
providing a feed stock supply of fabric material to a computer controlled cutting table system and cutting the fabric material into fabric components as required;
delivering the cut fabric components to a flotation table operable in conjunction with fabric sewing machine system and sewing the fabric components together.

16. The method of claim 10 wherein information and data is electronically communicated between each of the components within the system through a local area network.

17. The method of claim 10 further comprising the steps of:
maintaining an automated materials inventory and stocking system;
receiving framing and fabric material into inventory stock;
identifying the location of required material upon demand; and
delivering the material to the fabricating components of the system as required.
